(19) United States
(12) Patent Application Publication
(10) Pub. No.: US 2014/0139778 A1
(43) Pub. Date: May 22, 2014

(54) Middle Frame and Liquid Crystal Display Device

(71) Applicant: Shenzhen China Star Optoelectronics Technology Co. Ltd., Shenzhen, Guangdong (CN)

(72) Inventors: Lifeng Wang, Shenzhen City (CN); Yuchun Hsiao, Shenzhen City (CN)

(73) Assignee: Shenzhen China Star Optoelectronics Technology Co.,Ltd., Shenzhen, Guangdong (CN)

(21) Appl. No.: 13/702,287

(22) PCT Filed: Dec. 3, 2012
(86) PCT No.: PCT/CN12/85725

§ 371 Date: Dec. 5, 2012

(30) Foreign Application Priority Data
Nov. 22, 2012 (CN) 201210478854.1

(51) Int. Cl. G02F 1/1333

(52) U.S. Cl. CPC G02F 1/133308
USPC 349/58; 248/694

(57) ABSTRACT

The present invention provides a middle frame and liquid crystal display device. The middle frame includes a first support part and a second support part, the second support part being disposed perpendicularly to a top surface of the first support part, wherein the first support part further including a bottom surface, disposed oppositely to the top surface, wherein the bottom surface comprising a slant part, extending slantly from the bottom surface towards the top surface. During assembling the liquid crystal display device, the first support part slants, leading to the slanting of the second support part to press firmly against optical film. As such, the light leak problem in the liquid crystal display device is improved and the display quality if also improved.

### BACKGROUND OF THE INVENTION

1. Field of the Invention

The present invention relates to the field of liquid crystal displaying techniques, and in particular to a middle frame and liquid crystal display device.

2. The Related Arts

Referring to FIG. 1, FIG. 1 is a schematic view illustrating the structure of a known liquid crystal display device. As shown in FIG. 1, a known liquid crystal display device 10 comprises a back plate 11, a middle frame 12, a light source 13, a light-guiding plate 14 and an optical film 15, wherein the middle frame 12 comprises a first support part 121 and a second support part 122, perpendicular to each other, and the light-guiding plate 14 comprises an incident surface 141 and an light-emitting surface 142.

The first support part 121 is disposed on the back plate 11, and the light-guiding plate 14 is disposed above the back plate 11. The light source 13 is disposed on the side of the incident surface 141 of light-guiding plate 14, and the optical film 15 is disposed on the light-emitting surface 142 of light-guiding plate 14. The second support part 122 of the middle frame 12 is located above the optical film 15 and forming a gap 16 with the optical film 15.

To prevent the heat generated by the light source 13 from causing the light-guiding plate 14 to expand and deform to damage the light source 13, the known liquid crystal display device 10 further disposes a gap 17 between the incident surface 141 of light-guiding plate 14 and the light source 13.

However, the light emitted by the light source 3 may radiate in the gap 17 to leak through the gap 16 to cause light leak in liquid crystal display device 10 leading to reducing the display quality of the liquid crystal display device 10

### SUMMARY OF THE INVENTION

The technical issue to be addressed by the present invention is to provide a middle frame and liquid crystal display device, able to improve the light leak problem of the liquid crystal display device so as to improve the display quality of liquid crystal display device.

The present invention provides a middle frame, which comprises; a first support part and a second support part, the second support part being disposed perpendicularly to a top surface of the first support part, wherein the first support part further comprising a bottom surface, disposed oppositely to the top surface, wherein the bottom surface comprising a slant part, extending slantly from the bottom surface towards the top surface; wherein the first support part further comprising at least a side wall connecting the top surface and the bottom surface, the bottom surface comprising a level part parallel to the top surface; the slant part comprising a first end and a second end, the first end being connected to the level part and the second end being connected to the side wall, the slant part having a height of H and H satisfying the following equation: H=H1−H2, wherein H1 being a vertical distance from the top surface of the first support part to the first end of the slant part, and H2 being a vertical distance from the top surface of the first support part to the second end of the slant part; the H being less than 0.2 mm and the tilt angle of the slant part being less than 5°, wherein the tilt angle being the angle between the slant part and the horizontal level.

The present invention provides a middle frame, which comprises: a first support part and a second support part, the second support part being disposed perpendicularly to a top surface of the first support part, wherein the first support part further comprising a bottom surface, disposed oppositely to the top surface, wherein the bottom surface comprising a slant part, extending slantly from the bottom surface towards the top surface.

According to a preferred embodiment of the present invention, the first support part further comprises at least a side wall connecting the top surface and the bottom surface; the bottom surface comprises a level part parallel to the top surface; the slant part comprises a first end and a second end, the first end being connected to the level part and the second end being connected to the side wall, the slant part having a height of H and H satisfying the following equation: H=H1−H2, wherein H1 being a vertical distance from the top surface of the first support part to the first end of the slant part, and H2 being a vertical distance from the top surface of the first support part to the second end of the slant part.

According to a preferred embodiment of the present invention, the H is less than 0.2 mm and the tilt angle of the slant part is less than 5°, wherein the tilt angle is the angle between the slant part and the horizontal level.

According to a preferred embodiment of the present invention, the first support part further comprises a first side wall and a second side wall, disposed in parallel and connecting the top surface and the bottom surface; the slant part comprises a first end and a second end, the first end being connected to the first side wall and the second end being connected to the second side wall, the slant part having a height of H and H satisfying the following equation: H=H1−H2, wherein H1 being a vertical distance from the top surface of the first support part to the first end of the slant part, and H2 being a vertical distance from the top surface of the first support part to the second end of the slant part.

According to a preferred embodiment of the present invention, the H is less than 0.2 mm and the tilt angle of the slant part is less than 5°, wherein the tilt angle is the angle between the slant part and the horizontal level.

The present invention provides a liquid crystal display device, which comprises: a front frame; a back plate, forming an accommodation space with the front frame; a light-guiding plate, disposed on the back plate, the light-guiding plate comprising an incident surface and a light-emitting surface; an optical film, disposed on the light-emitting surface of the light-guiding plate; wherein the liquid crystal display device further comprising a middle frame, the middle frame comprising a first support part and a second support part, the second support part being disposed perpendicularly to a top surface of the first support part, wherein the first support part further comprising a bottom surface, disposed oppositely to the top surface, wherein the bottom surface comprising a slant part, extending slantly from the bottom surface towards the top surface; the first support part of the middle frame being disposed on the back plate and the second support part of the middle frame being disposed above the optical film so that the second support part pressing firmly against the optical film when the slant part of the first support part clinging to the back plate.

According to a preferred embodiment of the present invention, the first support part further comprises at least a side wall connecting the top surface and the bottom surface; the bottom surface comprises a level part parallel to the top surface; the slant part comprises a first end and a second end, the first end being connected to the level part and the second end being connected to the side wall, the slant part having a height of H and H satisfying the following equation: H=H1−H2, wherein H1 being a vertical distance from the top surface of the first support part to the first end of the slant part, and H2 being a vertical distance from the top surface of the first support part to the second end of the slant part.

According to a preferred embodiment of the present invention, the H is less than 0.2 mm and the tilt angle of the slant part is less than 5°, wherein the tilt angle is the angle between the slant part and the horizontal level.

According to a preferred embodiment of the present invention, the level distance from the first end of the slant part to the incident surface of the light-guiding plate is greater than the level distance from the second end of the slant part to the incident surface of the light-guiding plate.

According to a preferred embodiment of the present invention, the accommodation space has a height of H3, wherein. H1 is greater than H2 and H2 is greater than H3.

According to a preferred embodiment of the present invention, the first support part further comprises a first side wall and a second side wall, disposed in parallel and connecting the top surface and the bottom surface; the slant part comprises a first end and a second end, the first end being connected to the first side wall and the second end being connected to the second side wall, the slant part having a height of H and H satisfying the following equation: H=H1−H2, wherein H1 being a vertical distance from the top surface of the first support part to the first end of the slant part, and H2 being a vertical distance from the top surface of the first support part to the second end of the slant part.

According to a preferred embodiment of the present invention, the H is less than 0.2 mm and the tilt angle of the slant part is less than 5°, wherein the tilt angle is the angle between the slant part and the horizontal level.

According to a preferred embodiment of the present invention, the level distance from the first end of the slant part to the incident surface of the light-guiding plate is greater than the level distance from the second end of the slant part to the incident surface of the light-guiding plate.

According to a preferred embodiment of the present invention, the accommodation space has a height of H3, wherein H1 is greater than H2 and H2 is greater than H3.

The efficacy of the present invention is that to be distinguished from the state of the art. The present invention disposes the bottom surface of the first support part of the middle frame comprising a slant part extending from the bottom surface towards the top surface of the middle frame so that the first support part will slant due to the extrusion during assembling the liquid crystal display device, which leads to the slanting of the second support part. When the slant part of the bottom surface clings to the back plate, the second support part of the middle frame presses firmly against the optical film to prevent the light of the light source from light leak through between the optical film and the second support part. As such, the light leak problem in the liquid crystal display device is improved and the display quality if also improved.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing the structure of a known liquid crystal display device;

FIG. 2 is a schematic view showing the structure of a first embodiment of the liquid crystal display device according to the present invention;

FIG. 3 is a schematic view showing the structure of a middle frame in the liquid crystal display device of FIG. 2;

FIG. 4 is a schematic view showing the structure of the liquid crystal display device of FIG. 2 after assembly; and

FIG. 5 is a schematic view showing the structure of the middle frame of a second embodiment of the liquid crystal display device according to the present invention.

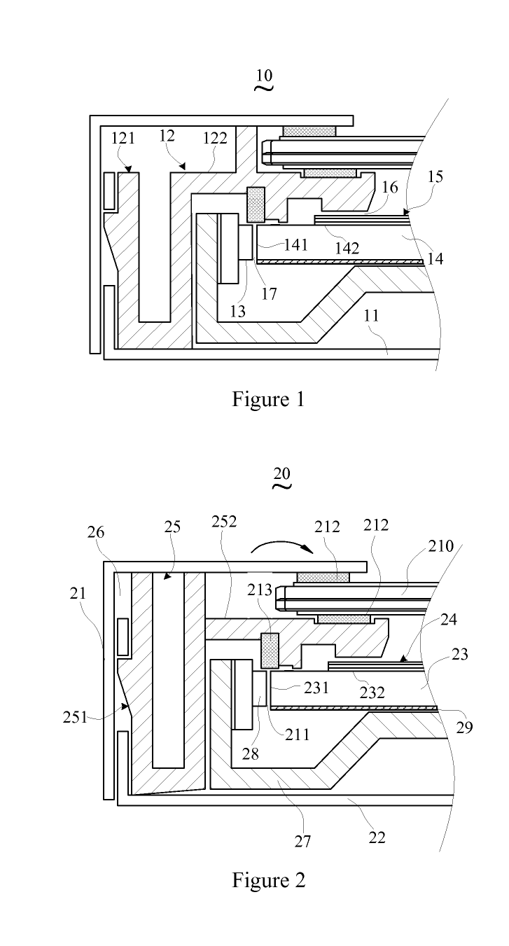

### DETAILED DESCRIPTION OF THE PREFERRED EMBODIMENTS

Referring to FIG. 2, FIG. 2 is a schematic view showing the structure of a first embodiment of the liquid crystal display device according to the present invention. As shown in FIG. 2, the liquid crystal display device 20 comprises a front frame 21, a back plate 22, a light-guiding plate 23, an optical film 24 and a middle frame 25.

In the instant embodiment, the front frame 21 and the back plate 22 form an accommodation space 26, for housing fixing and protecting different internal elements of the liquid crystal display device 20.

The light-guiding plate 23 is disposed on the back plate 22. The light-guiding plate 23 comprises an incident surface 231 and a light-emitting surface 232. The optical film 24 is disposed on the light-emitting surface 232 of the light-guiding plate 23 for making the emitted light from the light-guiding plate 23 uniform.

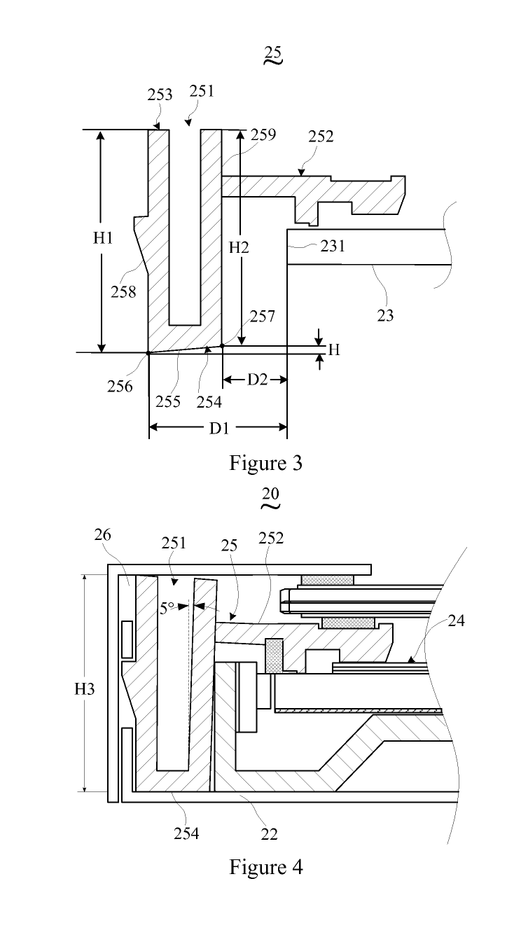

The middle frame 25 is disposed on the back plate 22, wherein the specific structure of the middle frame 25 refers to FIG. 3. FIG. 3 shows a schematic view of the structure of middle frame 25.

As shown in FIGS. 2-3, the middle frame 25 comprises a first support part 251 and a second support part 252. The first support part 251 comprises a top surface 253 and a bottom surface 254, disposed oppositely. The top surface 253 of the first support part 251 is perpendicular to the second support part 252. In the instant embodiment, the bottom surface 254 of the first support part 251 comprises a slant part 255, extending slantly from the bottom surface 254 towards the top surface 253.

Specifically, the first support part 251 further comprises a first side wall 258 and a second side wall 259, disposed in parallel and connecting the top surface 253 and the bottom surface 254. The slant part 255 comprises a first end 256 and a second end 257. The first end 256 is connected to the first side wall 258 and the second end 257 is connected to the second side wall 259. The height H of the slant part 255 satisfies the following equation:

H=H1−H2

wherein H1 is a vertical distance from the top surface 253 of the first support part 251 to the first end 256 of the slant part 255, and H2 is a vertical distance from the top surface 253 of the first support part 251 to the second end 257 of the slant part 255. In the instant embodiment, the H of the slant part 255 is preferably less than 0.2 mm and the tilt angle of the slant part 255 is preferably less than 5°, wherein the tilt angle is the angle between the slant part 255 and the horizontal level.

In the instant embodiment, the level distance D1 from the first end 256 of the slant part 255 to the incident surface 231 of the light-guiding plate 23 is greater than the level distance D2 from the second end 257 of the slant part to 255 the incident surface 231 of the light-guiding plate 23.

FIG. 4 is a schematic view showing the structure of the liquid crystal display device of FIG. 2 after assembly. Referring to FIGS. 2-4, because the bottom surface 254 of the first support part 251 is disposed with a slant part 255, the slant part 255 clings to the surface of the back plate 22 during assembling the liquid crystal display device 20, which causes the second support part 252 to slant downwards (i.e., towards optical film 24) and press firmly against on the optical film 24. The height of accommodation space 26 is H3, wherein H1 is greater than H2 and H2 is greater than H3. Therefore, during assembling the liquid crystal display device 20, the front frame 21 and the back plate 22 form the accommodation space 26 so that the first support part 251 is extruded by the front frame 21 and the back plate 22. Under the pressure, the slant part 255 will slant towards the direction shown in FIG. 2 until the slant part 255 clings completely to the back plate 22. The second support part 252 also follows the first support part 251 to slant, leading to press firmly against the optical film 24.

Furthermore, referring to FIG. 2, the liquid crystal display device 20 of the present embodiment further comprises a heat-dissipation plate 27, a light source 28, a reflector 29 and a liquid crystal display panel 210. The heat-dissipation plate 27 is disposed on the back plate 22. The light source 28 is disposed on the side wall of the heat-dissipation plate 27 and maintains a gap 211 from the incident surface 231 of the light-guiding plate 23 to prevent the heat generated by the light source 28 from expanding and deforming the light-guiding plate 23 to crush the light source 28. The reflector 29 is disposed between the heat-dissipation plate 27 and light-guiding plate 23. The liquid crystal display panel 210 is disposed between the second support part 252 and the front frame 21, and a buffer element 212 is disposed between the front frame and the liquid crystal display panel 210, and between the v and the second support part 252 to prevent the liquid crystal display panel 210 from damage by the second support part 252 or the front frame 21.

In the instant embodiment, the second support part 252 extends towards the light source 28 correspondingly along the gap 211 and a reflector element 213 is disposed on the extended part of the second support part 252. The reflector element 213 can reflect the light from the light source 28 back to the light-guiding plate 23 to improve the light utilization. Furthermore, the reflector element 213 is located closer to the light source 28 to reduce the transmission path of the light so as to reduce the light loss.

Compared to the known technique, the present invention disposes the bottom surface of the first support part 251 as a slant part structure so that the first support part 251 will slant due to the extrusion during assembling the liquid crystal display device 20, which leads to the slanting of the second support part 252 to press firmly against the optical film 24. As such, the light leak problem in the liquid crystal display device 20 is improved and the display quality if also improved.

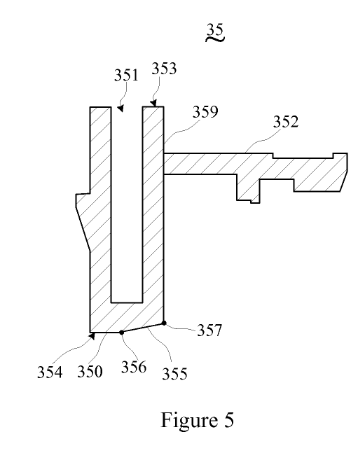

Referring to FIG. 5, FIG. 5 is a schematic view showing the structure of the middle frame of a second embodiment of the liquid crystal display device according to the present invention. As shown in FIG. 5, the middle frame 35 of the liquid crystal display device of the present embodiment differs from the middle frame 25 in the first embodiment in that: the bottom surface 354 of the middle frame 35 comprises a level part 350 and a slant part 355.

Specifically, the first support part 351 comprises at least a side wall 359 connecting the top surface 353 and the bottom surface 354. The bottom surface 354 comprises a level part 350 parallel to the top surface 353, and a slant part 355 connected to the level part 350. The slant part 355 comprises a first end 356 and a second end 357. The first end 356 is connected to the level part 350 and the second end 357 is connected to the side wall 359.

Similarly, the first support part 351 of the present embodiment will slant due to the extrusion during assembling the liquid crystal display device, which leads to the slanting of the second support part 352 to press firmly against the optical film. As such, the light leak problem in the liquid crystal display device is improved and the display quality if also improved.

In summary, through disposing the bottom surface of the first support part as a slant part extending from the bottom surface towards the top surface so that the first support part will slant due to the extrusion during assembling the liquid crystal display device, which leads to the slanting of the second support part. When the slant part of the bottom surface clings to the back plate, the second support part of the middle frame presses firmly against the optical film. As such, the light leak problem in the liquid crystal display device is improved and the display quality if also improved.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A middle frame, which comprises: a first support part and a second support part, the second support part being disposed perpendicularly to a top surface of the first support part, wherein the first support part further comprising a bottom surface, disposed oppositely to the top surface, wherein the bottom surface comprising a slant part, extending slantly from the bottom surface towards the top surface;
wherein the first support part further comprising at least a side wall connecting the top surface and the bottom surface, the bottom surface comprising a level part parallel to the top surface: the slant part comprising a first end and a second end, the first end being connected to the level part and the second end being connected to the side wall, the slant part having a height of H and H satisfying the following equation:
H=H1−H2,
wherein H1 being a vertical distance from the top surface of the first support part to the first end of the slant part, and H2 being a vertical distance from the top surface of the first support part to the second end of the slant part;
the H being less than 0.2 mm and the tilt angle of the slant part being less than 5°, wherein the tilt angle being the angle between the slant part and the horizontal level.

2. A middle frame, which comprises: a first support part and a second support part, the second support part being disposed perpendicularly to a top surface of the first support part, wherein the first support part further comprising a bottom surface, disposed oppositely to the top surface, wherein the bottom surface comprising a slant part, extending slantly from the bottom surface towards the top surface.

3. The middle frame as claimed in claim 2, characterized in that the first support part further comprises at least a side wall connecting the top surface and the bottom surface: the bottom surface comprises a level part parallel to the top surface; the slant part comprises a first end and a second end, the first end being connected to the level part and the second end being connected to the side wall, the slant part having a height of H and H satisfying the following equation;
H=H1−H2,
wherein H1 being a vertical distance from the top surface of the first support part to the first end of the slant part, and H2 being a vertical distance from the top surface of the first support part to the second end of the slant part.

4. The middle frame as claimed in claim 3, characterized in that the H is less than 0.2 mm and the tilt angle of the slant part is less than 5°, wherein the tilt angle is the angle between the slant part and the horizontal level.

5. The middle frame as claimed in claim 2, characterized in that the first support part further comprises a first side wall and a second side wall, disposed in parallel and connecting the top surface and the bottom surface; the slant part comprises a first end and a second end, the first end being connected to the first side wall and the second end being connected to the second side wall, the slant part having a height of H and H satisfying the following equation:
H=H1−H2,
wherein H1 being a vertical distance from the top surface of the first support part to the first end of the slant part, and H2 being a vertical distance from the top surface of the first support part to the second end of the slant part.

6. The middle frame as claimed in claim 5, characterized in that the H is less than 0.2 mm and the tilt angle of the slant part is less than 5°, wherein the tilt angle is the angle between the slant part and the horizontal level.

7. A liquid crystal display device, which comprises:
a front frame;
a back plate, forming an accommodation space with the front frame;
a light-guiding plate, disposed on the back plate, the light-guiding plate comprising an incident surface and a light-emitting surface;
an optical film, disposed on the light-emitting surface of the light-guiding plate;
wherein the liquid crystal display device further comprising a middle frame, the middle frame comprising a first support part and a second support part, the second support part being disposed perpendicularly to a top surface of the first support part, wherein the first support part further comprising a bottom surface, disposed oppositely to the top surface, wherein the bottom surface comprising a slant part, extending slantly from the bottom surface towards the top surface;
the first support part of the middle frame being disposed on the back plate and the second support part of the middle frame being disposed above the optical film so that the second support part pressing firmly against the optical film when the slant part of the first support part clinging to the back plate.

8. The liquid crystal display device as claimed in claim 7, characterized in that characterized in that the first support part further comprises at least a side wall connecting the top surface and the bottom surface; the bottom surface comprises a level part parallel to the top surface; the slant part comprises a first end and a second end, the first end being connected to the level part and the second end being connected to the side wall, the slant part having a height of H and H satisfying the following equation:
H=H1−H2,
wherein H1 being a vertical distance from the top surface of the first support part to the first end of the slant part, and H2 being a vertical distance from the top surface of the first support part to the second end of the slant part.

9. The liquid crystal display device as claimed in claim 8, characterized in that the H is less than 0.2 mm and the tilt angle of the slant part is less than 5 wherein the tilt angle is the angle between the slant part and the horizontal level.

10. The liquid crystal display device as claimed in claim 8, characterized in that a level distance from the first end of the slant part to the incident surface of the light-guiding plate is greater than a level distance from the second end of the slant part to the incident surface of the light-guiding plate.

11. The liquid crystal display device as claimed in claim 8, characterized in that the accommodation space has a height of H3, wherein H1 is greater than H2 and H2 is greater than H3.

12. The liquid crystal display device as claimed in claim 7, characterized in that the first support part further comprises a first side wall and a second side wall, disposed in parallel and connecting the top surface and the bottom surface: the slant part comprises a first end and a second end, the first end being connected to the first side wall and the second end being connected to the second side wall, the slant part having a height of H and H satisfying the following equation;
H=H1−H2,
wherein H1 being a vertical distance from the top surface of the first support part to the first end of the slant part, and H2 being a vertical distance from the top surface of the first support part to the second end of the slant part.

13. The liquid crystal display device as claimed in claim 12, characterized in that the H is less than 0.2 mm and the tilt angle of the slant part is less than 5, wherein the tilt angle is the angle between the slant part and the horizontal level.

14. The liquid crystal display device as claimed in claim 12, characterized in that a level distance from the first end of the slant part to the incident surface of the light-guiding plate is greater than a level distance from the second end of the slant part to the incident surface of the light-guiding plate.

15. The liquid crystal display device as claimed in claim 12, characterized in that the accommodation space has a height of H3, wherein H1 is greater than H2 and H2 is greater than H3.
